(19) United States
(12) Patent Application Publication
(10) Pub. No.: US 2002/0001159 A1
(43) Pub. Date: Jan. 3, 2002

(54) Magnetic head device having resin stop structure preventive of flowing and scattering of insulating resin

(75) Inventor: Hideto Ando, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/896,064

(22) Filed: Jun. 29, 2001

(30) Foreign Application Priority Data
Jul. 3, 2000 (JP) 2000-205566

(51) Int. Cl. G11B 5/39; G11B 21/00

(52) U.S. Cl. 360/322; 360/281.7; 360/271.9

(57) ABSTRACT

A magnetic head device has a wiring board on which are formed first electrode pads connected to a head chip through lead wires and second electrode pads electrically connected to the first electrode pads and arranged for external connection. The lead wires connected to the first electrode pads are covered with an insulating resin. An aperture is formed in the wiring board so as to lie between the first electrode pads and the second electrode pads.

### BACKGROUND OF THE INVENTION

1. Field of the Invention

The present invention relates to a magnetic head device for use on a helical-scan magnetic recording/reproducing apparatus and, more particularly, to a magnetic head device for use in a video-tape recorder (VTR) or in a magnetic recording/reproducing apparatus for recording and/or reproducing images handled by computers.

2. Description of the Related Art

FIGS. 5 and 6 show a conventional magnetic head device known as a “combination-type” magnetic head. The magnetic head device, denoted by 31, is of an induction-coil type, and has a pair of head chips 34a, 34b which are also collectively denoted by 34 and which are responsible for writing and reading information, respectively. These head chips 34 are fixed to corresponding protrusions on a head base 33 which is made of brass and which serves as a base member of the magnetic head device 31, by means of an insulating resin 40 serving as an adhesive, such as, for example, an acrylic resin, epoxy resin, or the like. These head chips 34a and 34b respectively have ferrite cores 34a′ and 34b′ on which are wound lead lines 36 to form coils. Lead lines 36 are extended from both ends of each coil, so as to serve as conductor lines. A wiring board 32 is bonded by heat and pressure to the surface of the head base 33 opposite to the surface carrying the head chips 34.

Four first electrode pads 34a, 34b, 35c and 35d (collectively denoted by 35) and four second electrode pads 38a, 38b, 38c and 38d (collectively denoted by 38) are formed on the surface of the wiring board 32. The first electrode pads are electrically connected to corresponding second electrode pads through conductors laid on the wiring board 32. Two lead lines 36 are laid to extend from each of the head chips 34a, 34b via a channel 41 formed between the pair of head bases 33, so as to be connected to the first electrode pads 35 by soldering as at 35e. More specifically, the pair of lead wires 36 leading from one 34a of the head chips are connected are connected to the first electrode pads 35a and 34b, while the pair of lead wires 36 leading from the other head chip 34b are connected to the first electrode pads 35c and 35d. The areas on the printed wiring board 32 other than the regions where the electrode pads are formed is coated with an insulating resin such as an epoxy resin. An insulating resin 37 such as an epoxy resin covers the lead wires 36 extending from the head chips 34 to the first electrode pads 35, inclusive of the soldered portions 35e, so as to protect these lead wires 36. The insulating resin 37 is applied by means of a dispenser or the like and is then cured.

The second electrode pads 38 are to be connected to an internal wiring (not shown) of a rotary cylinder head of a helical-scan magnetic recording/reproducing apparatus which is used on a computer and which incorporates the magnetic head 31. The magnetic head 31 is fixed in the rotary cylinder head by means of, for example, a screw which is driven through a hole 39 formed in the head base 33.

The current trend towards miniaturization of magnetic recording/reproducing apparatuses has given a rise to the demand for smaller rotary cylinders and smaller magnetic head devices. This naturally leads to smaller surface area of the printed wiring board and, hence, a smaller distance between the first electrode pads 35 and the second electrode pads 38 on the printed wiring board 32.

The small distance between the first electrode pads 35 and the second electrode pads 38 poses a problem. To be ore specific, the insulating resin, which is applied to cover the lead wires 36 between the first electrode pads 35 and the head chips 34 and soldered portions 35e, undesirably flows during the application thereof, or is scattered by inadequate manner of application work. The flowing or scattered resin is deposited on the second electrode pads 38, thus causing impediment to the electrical connection between the second electrode pads 38 and the external lead wires (not shown).

### SUMMARY OF THE INVENTION

Accordingly, it is an object of the present invention to provide a highly reliable magnetic head device in which, despite a diminished surface area of a printed wiring board, lead wires between head chips and first electrode pads and soldered portions are satisfactorily covered and protected by an insulating resin, without allowing undesirable deposition of the insulating resin on the second electrode pads.

To this end, according to the present invention, there is provided a magnetic head device, comprising: a head chip; a head base carrying the head chip; a wiring board fixed to the head base and having first electrode pads and second electrode pads formed thereon, the first electrode pads being electrically connected to the head chip via lead wires extending from the head chip, the second electrode pads being electrically connected to the first electrode pads and being arranged for external connection; an insulating resin covering the lead wires connected to the first electrode pads; and a resin-flow stopping structure disposed between the first electrode pads and the second electrode pads.

With these features of the present invention, when the insulating resin is applied, excessive resin flowing on the wiring board is prevented by the resin-flow stopping structure from reaching the second electrode pads, whereby undesirable deposition of the insulating resin on the second electrode pads is prevented.

In addition, the risk of deposition of the insulating resin on the second electrode pads, which may occur due to inferior resin applying work, is greatly suppressed by virture of the feature that the second electrode pads are spaced apart from the first electrode pads by a distance large enough to prevent such undesirable deposition.

In the magnetic head device according to the present invention, the wiring board may further has third electrode pads for use in an inspection and electrically connected to the first and second electrode pads, and the resin-flow stopping structure may be disposed between the first electrode pads and the third electrode pads.

These features prevent undesirable deposition of the insulating resin on the third electrode pads, thus allowing the inspection to be performed smoothly and without delay.

The third electrode pads may be positioned between the first electrode pads and the second electrode pads.

This arrangement permits an efficient use of the limited area on the wiring board, thus eliminating the necessity for the use of a greater wiring board.

In the magnetic head device of the present invention, the wiring board may further have a fourth electrode pad for use in an inspection, the fourth electrode pad being electrically connected to a first electrode pad other than the first electrode pads that are connected to the third electrode pads, and the resin-flow stopping structure may be disposed between the first electrode pads and the fourth electrode pad.

These features effectively prevent deposition of the insulating resin on the fourth electrode pads, thus contributing to improvement in the reliability of the magnetic head device.

The head chip may comprise a magnetoresistive element having electrode layers and a magnetic shield layer. When the magnetoresistive element is used, the third electrode pads are electrically connected to the electrode layers of the magnetoresistive element, and the fourth electrode pad are electrically connected to the magnetic shield layer of the magnetoresistive element.

These features enable an inspection for confirming the state of smear which occurs in the course of a tape lapping process, thus offering high performance and reliability of the magnetic head device.

In the magnetic head device of the present invention, the resin-flow stopping structure may comprise an aperture formed in the wiring board.

This feature permits the resin-flow stopping structure to be easily implemented.

These and other objects, features and advantages of the present invention will become clear from the following description of the preferred embodiments when the same is read in conjunction with the accompanying drawings.

### BRIEF DESCRIPTION OF THE DRAWINGS

FIG. 1 is a plan view of a magnetic head device embodying the present invention;

FIG. 2 is a side elevational view of the magnetic head device shown in FIG. 1;

FIG. 3 is an illustration of a head chip which is used in the magnetic head device of the present invention and which employs a magnetoresistive element;

FIG. 4 is an illustration of a tape lapping process performed on the magnetoresistive element used in the magnetic head device of the present invention;

FIG. 5 is a plan view of a known magnetic head device; and

FIG. 6 is a side elevational view of the magnetic head device shown in FIG. 5.

### DESCRIPTION OF THE PREFERRED EMBODIMENT

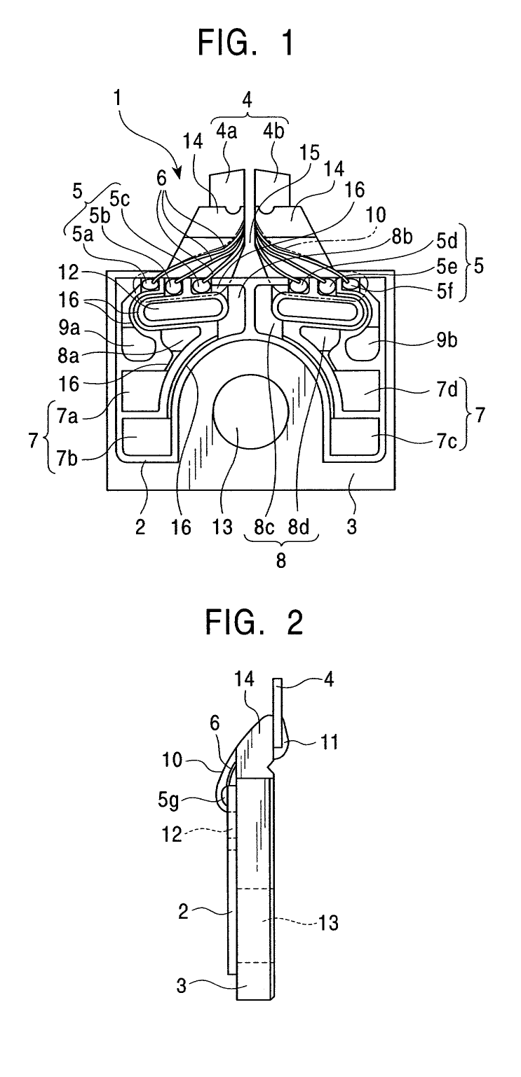

An embodiment of the magnetic head device in accordance with the present invention will be described with reference to FIGS. 1 to 4.

Referring first to FIGS. 1 and 2, a magnetic head device 1, which is of a so-called combination type, has information reading head chips denoted respectively y 4a and 4b and collectively designated at 4. The magnetic head device 1 also has a head base 3 and a wiring board 2 which is coated by an insulating resin or adhesive denoted by 10. The insulating resin 10 is a transparent, electrically insulating resin such as, for example, an acrylic resin or an epoxy resin.

The head base 3 serves as a substrate of the magnetic head device 1, and is made of brass. A fixing hole 13 is formed in the center of the head base 3 and is used when the magnetic head device 1 is mounted in the rotary head. A pair of protrusions 14, on which the head chips are to be mounted, are formed on the upper edge of the head base 3. These protrusions are separated from each other by a channel 15. Lead wires 6 lead from the head chips 4 for electrical connection.

The head chips 4 are fixed to the protrusions 14 on the upper edge of the head base 3, by means of an insulating resin or adhesive 11 such as an acrylic resin or an epoxy resin. The head chips 4 incorporate magnetoresistive elements.

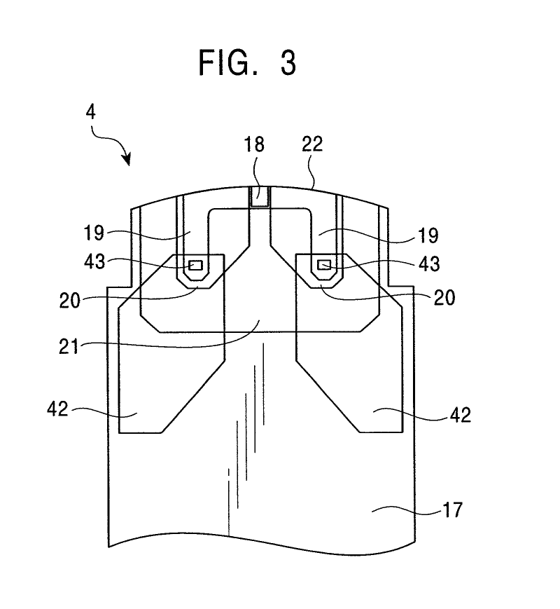

The structure of each head chip 4 will be described with specific reference to FIG. 3 which is a sectional view of the head chip 4. The head chip 4 has a base plate 17 on which is formed a magnetic shield layer 21. A non-magnetic, non-conductive layer (not shown) is formed on the magnetic shield layer 21. A bias layer 20 and a magnetoresistive element layer 18 are formed on the non-magnetic, nonconductive layer. The bias layer 20 is overlain by another non-magnetic, non-conductive layer (not shown) having a contact hole 43 which provides electrical connection between electrode layers 42 and the bias layer 20. The bias layer 20 has a protuberance 19 which is formed in the course of the process for forming the magnetoresistive element layer 18. The bias layer 20 serves to apply a magnetic bias to the magnetoresistive element layer 18, while the magnetic shield layer 18 serves to magnetically shield the magnetoresistive element layer 18. Although not shown, another magnetic shield layer is provided so as to cooperate with the magnetic shield layer in sandwiching therebetween the magnetoresistive element layer 18. These two magnetic shield layers are connected to each other.

Three lead wires 6 (not shown in FIG. 3) are led from both electrode layers 42 and the magnetic shield layer 21, and are extended towards the wiring board 2.

The wiring board 2 has an inverse U-like shape so as to clear the fixing hole 13. On the surface of the wiring board 2 are formed a first group of first electrode pads 5a, 5b and 5c and a second group of first electrode pads 5d, 5e and 5f. These two groups of the first electrode pads, collectively denoted by 5, are arranged in symmetry with respect to a center line which extends in the up and down direction as viewed in FIG. 1. Likewise, formed symmetrically on the surface of the wring board 2 are second electrode pads 7 (7a, 7b; 7c, 7d), third electrode pads 8(8a, 8b; 8c, 8d), and fourth electrode pads 9 (9a; 9b). The first electrode pad 5a and the fourth electrode pad 9a are connected through an electrode line 16 laid on the wiring board 2. Similarly, the first electrode pad 5b, the third electrode pad 8a and the second electrode pad 7a are connected through electrode lines 16 laid on the wiring board 2. Likewise, electrode lines 16 laid on the wiring board 2 provide electrical connections between the first electrode pad 5c and the second electrode pad 7b via the third electrode pad 8b, between the first electrode pad 5d and the second electrode pad 7c via the third electrode pad 8c, between the first electrode pad 5e and the second electrode pad 7d via the third electrode pad 8d, and between the first electrode pad 5f and the fourth electrode pad 9b.

Lead lines 6 coated with an insulating material extend through the channel 15 between the head chips 4 so as to be connected at their ends to the first electrode pads 5 by soldering at connecting portions 5g (see FIG. 2). The lead lines 6 inclusive of the connecting portions 5g are covered by a transparent insulating resin 10 so as to be protected from mechanical impact. The insulating resin 10 is, for example, a UV-curable acrylic resin or a thermosetting epoxy resin.

The second electrode pads 7a to 7d, which are connected to the first electrode pads 5b to 5e by the electrode lines 16, are connected to internal wiring (not shown) of a rotary cylinder head of a helical-scan magnetic recording/reproducing apparatus which is mounted in a computer and which incorporates the magnetic head device 1. The magnetic head device 1 is fixed in the rotary cylinder head by means of, for example, a screw by using the fixing hole 13 formed in the head base 3. Electrode portions inclusive of the electrode lines 16, except for the electrode pads, are print-coated by an insulating resin such as an epoxy resin. Apertures 12 are formed in the printed wiring board 2 to separate the second electrode pads 7 and the first electrode pads 5 from each other, so as to serve as resin stopping portions. When the insulating resin 10 is applied to cover the lead lines 6 connected to the first electrode pads, the resin stopping portions constituted by the apertures 12 serve to prevent the insulating resin from spreading along the surface of the wiring board 2, whereby the undesirable deposition of the insulating resin to the second electrode pads is avoided.

The third electrode pads 8 are used for setting thereon an inspection probe which inspects the degree of lapping achieved in a tape-lapping process which will be described later. The third electrode pads 8 are also used in the final inspection. The apertures 12 also lie between the third electrode pads 8 and the first electrode pads. When the insulating resin 10 is applied to cover the lead lines 6 connected to the first electrode pads, the apertures 12 serve to prevent the insulating resin from spreading along the surface of the wiring board 2, whereby the undesirable deposition of the insulating resin to the third electrode pads is avoided.

The third electrode pads are positioned between the first electrode pads 5 and the second electrode pads 7. This is because the first electrode pads 5 are essentially provided on an upper portion of the wiring board 2 for the convenience of the electrical connection to the head chips 4, while the second electrode pads 7 are disposed in a lower portion of the wiring board 2 due to requirement concerning the internal structure of the rotary cylinder in which the magnetic head device 1 is to be mounted.

Thus, in order to save the space by making efficient use of the limited area, it is preferred feasible to dispose the third electrode pads 8 in the region between the first electrode pads 5 and the second electrode pads 8.

When a tape lapping is conducted on the sliding surfaces 22 of the head chips 4 of the magnetic head device 1, the materials of the magnetic shield layer 21 and the electrode layers 42 are spread over the take sliding surfaces 22 of the head chips 4, due to plasticity f these materials. This phenomenon is generally known as “smear”. The fourth electrode pads 9 are used for the purpose of electrical inspection to determine the state of such smear. More specifically, the fourth electrode pads 9a and 9b are connected to the magnetic shield layers 21 of the head chips 4 of the magnetic head device 1, via the first electrode pads 5a and 5f. The third electrode pads 8 are connected to two electrode layers 42 associated with the magnetoresistive layers 18 of each head chip 4. It is therefore possible to know the state of any short-circuiting between the magnetoresistive element layer 18 and the associated electrode layer 42, by measuring the electrical resistance between the third electrode pad 8 and the fourth electrode pad 9. Thus, the fourth electrode pads 9 are electrically isolated from the second electrode pads 7 and the third electrode pads 8 on the wiring board 2.

The apertures 12 intervene the fourth electrode pads 9 and the first electrode pads 5 on the wiring board 2, thereby preventing the insulating resin 10 from flowing and spreading on the wiring board 2, thereby preventing deposition of this insulating resin on the fourth electrode pads, when the insulating resin 10 is applied to cover the lead wires 6 leading from the first electrode pads.

More specifically, the first electrode pads 5 are separated from other electrode pads, i.e., the second electrode pads 7, third electrode pads 8 and the fourth electrode pads 9, by the apertures 12 which are elongated and which are formed in the wiring board 2. When the connecting portions 5a at which the lead wires 6 are soldered to the first electrode pads 5 are covered by the insulating resin (adhesive) applied by, for example, a dispenser, there is a risk that excess insulating resin flows along the surface of the wiring board 2. In this embodiment, however, the flowing resin cannot reach the second, third and fourth electrode pads, because the flowing resin falls into the apertures 12, whereby deposition of the insulating resin on these electrode pads is avoided.

There is also a risk that the insulating resin is attached to an area around the target position, due to inferior resin applying work. Such wrong application of the insulating resin, however, does not cause contamination of the second, third and fourth electrode pads with the insulating resin, because these electrode pads are sufficiently spaced apart from the first electrode pads by the intervening apertures 12.

A description will now be given of a process for producing the magnetic head device 1 of the present invention. The process begins with a step for preparing a structure composed of the head base 3 and the wiring board 2 which has the apertures 12 and which is bonded to the head base 3 by heat and pressure. Then, the head chips 4 each having the magnetoresistive element layer 18 are aligned with two protrusions 14 on the head base 3, and are secured thereto by means of a UV-curable acrylic resin or a thermosetting epoxy resin. Then, the resin is cured or set by application of UV rays or heat, thereby fixing the head chips 4 to the protrusions 14 and, hence, to the head base 3. Then, lead wires 6 are led from the fixed head chips 4a and 4b to the upper edge of the wiring board 2, via the channel 15 formed between the protrusions 14. The ends of these lead wires 6 are then soldered to corresponding first electrode pads 5a, 5b, 5c, 5d, 5e and 5f. More specifically, the lead wires 6 led from the two electrode layers 42 of one 4a of the head chips are connected to the first electrode pads 5b and 5c, and the lead wire 6 leading from the magnetic shield layer 21 of this head chip 4a is connected to the first electrode pad 5a. Likewise, the lead wires 6 led from the two electrode layers 42 of the other 4b of the head chips are connected to the first electrode pads 5d and 5e and the lead wire 6 leading from the magnetic shield layer 21 of this head chip 4b is connected to the first electrode pad 5f.

After the soldering of the ends of the lead wires 6 to the first electrode pads 5, the portions of the lead wires 6 laid on the wiring board 2 and the head base 3, inclusive of the soldered connecting portions 5g, are coated with a UV-curable acrylic resin or a thermosetting epoxy resin. The resin is then hardened by application of UV rays or heat.

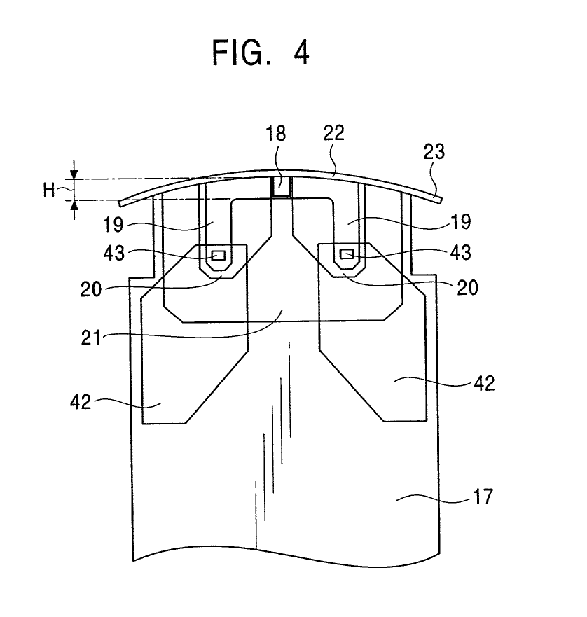

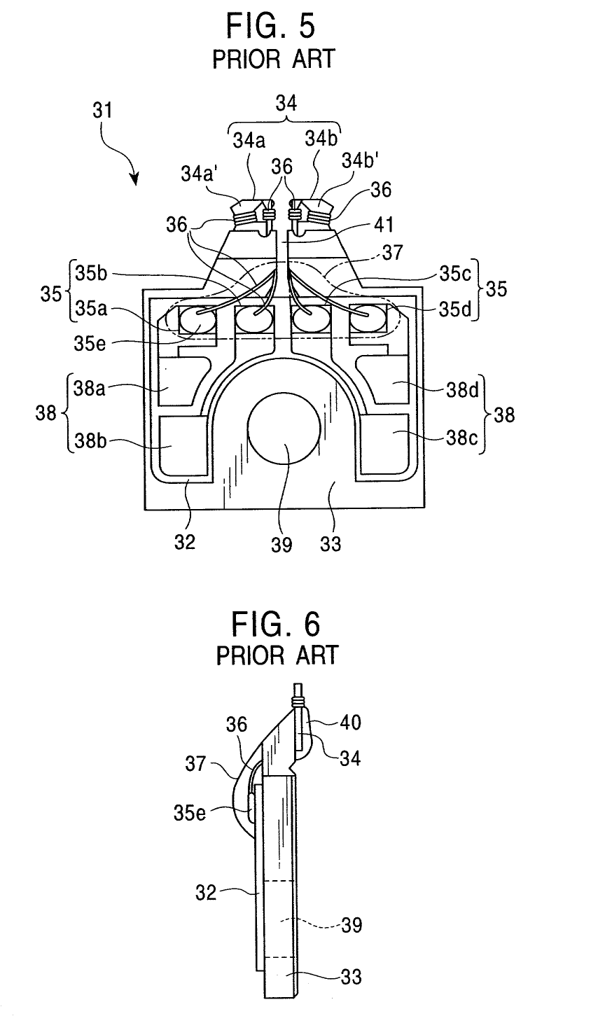

The magnetic head device 1 thus assembled is then subjected to a tape lapping process. As shown in FIG. 4, the lapping is performed by means of a lapping tape 23 which rubs the tape sliding surface 22 of the head chip 4 of the magnetic head device 1 which is fixed on a jig. More specifically, the lapping tape 23 rubs the tape sliding surface 22 in the directions perpendicular to the plane of the sheet of the drawing. The tape lapping process is conducted for the purpose of improving the affinity to a magnetic tape which is a recording medium. Another purpose of the tape lapping process is to achieve a predetermined resistivity of the magnetoresistive element layer 18, by adjusting the breadth of this layer 18, i.e., the height H of the magnetoresistive element. In order to optimize the resistivity of the magnetoresistive element layer 18, the lapping with the lapping tape is executed while the resistance between the third electrode pads 8a, 8b and the third electrode pads 8c, 8d is monitored. The lapping is ceased when the resistance value monitored through the third electrode pads 8 has reached a predetermined value. Finally, the resistance values between the third electrode pads and the fourth electrode pads are measured and checked to confirm that there is no short-circuiting between the magnetic shield layer 21 and the electrode layer 19 attributable to any smear. Products of the magnetic head device 1 exhibiting any short-circuiting due to smear are discarded as being unacceptable goods.

While the invention has been described through illustration of an embodiment which is a combination-type magnetic head device having a couple of head chips, it is to be understood that the described embodiments is only illustrative and the invention may be carried out with a single head chip as well. The magnetic head device of the present invention can be implemented in the form of a device other than the described magnetoresistive magnetic head device, e.g., an induction-coil magnetic head device.

While in the illustrated embodiment the lead wires 6 having insulating coat thereon and led from the head chips 4 are connected to the first electrode pads 5 by soldering, this is only illustrative and the electrical connections between the head chips 4 and the first electrode pads 5 may be achieved by a tape-like FPC (Flexible Printed Circuit). The FPC when used may be connected to the head chips 4 and the first electrode pads 5 by ball bonding method.

While the resin-flow stopping structure has been described as being apertures formed in the wiring board 2, any type of structure can be adopted equally well such as a recesses or protrusions that can receive or retain the flowing resin.

Although the invention has been described through its specific form, it is to be understood that the described embodiments are only illustrative and various changes and modifications may be imparted thereto without departing from the scope of the present invention which is limited solely by the appended claims.

What is claimed is:

1. A magnetic head device, comprising:
a head chip;
a head base carrying said head chip;
a wiring board fixed to said head base and having first electrode pads and second electrode pads formed thereon, said first electrode pads being electrically connected to said head chip via lead wires extending from said head chip, said second electrode pads being electrically connected to said first electrode pads and being arranged for external connection;
an insulating resin covering said lead wires connected to said first electrode pads; and
a resin-flow stopping structure disposed between said first electrode pads and said second electrode pads.

2. A magnetic head device according to claim 1, wherein said wiring board further has third electrode pads for use in an inspection and electrically connected to said first and second electrode pads, and wherein said resin-flow stopping structure is disposed between said first electrode pads and said third electrode pads.

3. A magnetic head device according to claim 2, wherein said third electrode pads are positioned between the first electrode pads and said second electrode pads.

4. A magnetic head device according to claim 3, wherein said wiring board further has a fourth electrode pad for use in an inspection, said fourth electrode pad being electrically connected to a first electrode pad other than the first electrode pads that are connected to said third electrode pads, and wherein said resin-flow stopping structure is disposed between said first electrode pads and said fourth electrode pad.

5. A magnetic head device according to claim 4, wherein said head chip comprises a magnetoresistive element having electrode layers and a magnetic shield layer, said third electrode pads being electrically connected to said electrode layers of said magnetoresistive element, said fourth electrode pad being electrically connected to said magnetic shield layer of said magnetoresistive element.

6. A magnetic head device according to claim 1, wherein said resin-flow stopping structure comprises an aperture formed in said wiring board.
